(19) United States
(12) Patent Application Publication
(10) Pub. No.: US 2015/0141883 A1
(43) Pub. Date: May 21, 2015

(54) SEXUAL STIMULATION DEVICES

(71) Applicant: LOVER HEALTH SCIENCE AND TECHNOLOGY CO., LTD, Huzhou (CN)

(72) Inventor: Wei Wu, Huzhou (CN)

(73) Assignee: LOVER HEALTH SCIENCE AND TECHNOLOGY CO., LTD

(21) Appl. No.: 14/603,847

(22) Filed: Jan. 23, 2015

Related U.S. Application Data
(63) Continuation of application No. PCT/CN2013/086788, filed on Nov. 8, 2013.

(51) Int. Cl. A61H 19/00

(52) U.S. Cl. CPC A61H 19/34; A61H 1/00
USPC 601/80

(57) ABSTRACT

A sexual stimulation device for a female user is provided. The stimulation device includes a first pad with a first width dimension configured for placement against a pubic area of the user and a second pad with a second width dimension configured for placement inside a vagina of the user without significant obstruction. The stimulation device also includes a first vibrating motor placed into the first pad. The stimulation device further includes a connecting member with a third width dimension for connecting the first pad and the second pad and configured to maintain a bending angle between the first pad and the second pad set by the user. The first width dimension, the second width dimension, and the third width dimension are substantially similar. The first pad moves driven by the first vibrating motor.

### CROSS REFERENCE TO RELATED APPLICATIONS

This application is a continuation of International Application Serial No. PCT/CN2013/086788 filed on Nov. 8, 2013, the entire contents of which are hereby incorporated by reference.

### FIELD OF INVENTION

The present invention relates to the field of sexual paraphernalia and, more particularly, to a sexual stimulation device intended for use by a woman.

### BACKGROUND

There are numerous devices available for use by a woman for sexual stimulation. They include products that are entirely manually operated, and achieve stimulation by shape and/or texture, and products that are provided with internal motors that achieve stimulation by shape, texture and vibration. These devices can generally be used to stimulate only one area at a time. However, it is known that there are at least three distinct effective genital stimulation areas in most women, namely the clitoris and surrounding shell, the inner surface of the vagina and the so-called G-spot, a nerve reflex area inside the vagina, along the anterior surface.

The disclosed stimulation devices are directed at solving one or more problems set forth above and other problems.

### BRIEF SUMMARY OF THE DISCLOSURE

One aspect of the present disclosure provides a sexual stimulation device for a female user. The stimulation device includes a first pad with a first width dimension configured for placement against a pubic area of the user and a second pad with a second width dimension configured for placement inside a vagina of the user without significant obstruction. The stimulation device also includes a first vibrating motor placed into the first pad. The stimulation device further includes a connecting member with a third width dimension for connecting the first pad and the second pad and configured to maintain a bending angle between the first pad and the second pad set by the user. The first width dimension, the second width dimension, and the third width dimension are substantially similar. The first pad moves driven by the first vibrating motor.

Other aspects of the present disclosure can be understood by those skilled in the art in light of the description, the claims, and the drawings of the present disclosure.

### BRIEF DESCRIPTION OF THE DRAWINGS

FIG. 1A illustrates an exemplary device consistent with the disclosed embodiments;

FIG. 1B illustrates an exemplary charger consistent with the disclosed embodiments;

FIG. 2 illustrates a cross-sectional view of an exemplary device consistent with the disclosed embodiments;

FIG. 3 illustrates a front view of an outer pad of an exemplary device consistent with the disclosed embodiments;

FIG. 4 illustrates a back view of an inner pad of an exemplary device consistent with the disclosed embodiments;

FIG. 5A illustrates an exemplary device consistent with the disclosed embodiments in an open state;

FIG. 5B illustrates an exemplary device consistent with the disclosed embodiments in a close state;

FIG. 6 illustrates an exemplary circuit diagram used in an exemplary device consistent with the disclosed embodiments;

FIG. 7 illustrates the moving directions of an exemplary device consistent with the disclosed embodiments;

FIG. 8 illustrates the moving directions of an exemplary device consistent with the disclosed embodiments;

FIG. 9A and 9B illustrate an exemplary device consistent with the disclosed embodiments;

FIG. 10 illustrates an exemplary circuit diagram used in an exemplary remote consistent with the disclosed embodiments; and

FIG. 11 illustrates an exemplary remote consistent with the disclosed embodiments.

### DETAILED DESCRIPTION

Reference will now be made in detail to exemplary embodiments of the invention, which are illustrated in the accompanying drawings. Wherever possible, the same reference numbers will be used throughout the drawings to refer to the same or like parts.

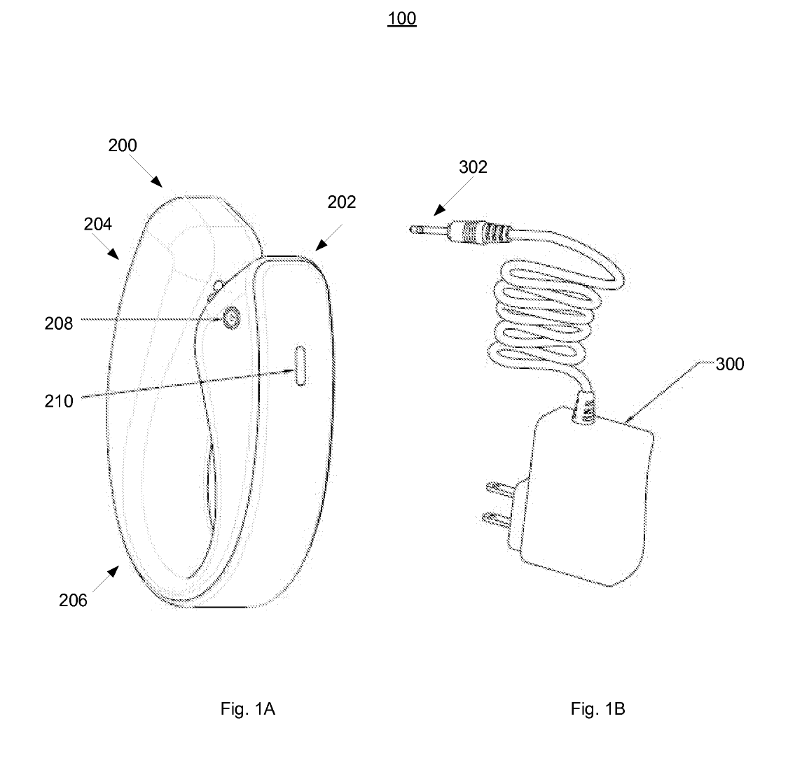

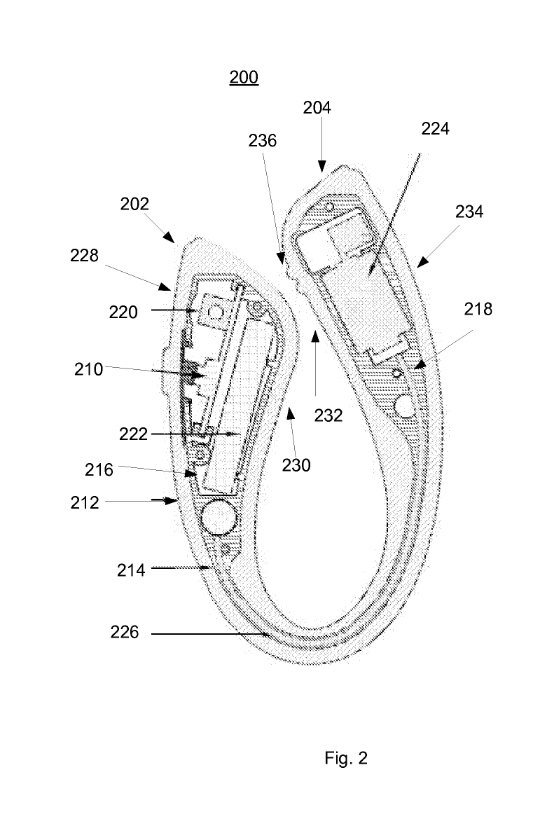

FIG. 1A and 1B illustrate an exemplary sexual stimulation device 100 consistent with the disclosed embodiments. As shown in FIGS. 1A and 1B, the device 100 includes a stimulator 200 and a charger 300. The stimulator 200 is anatomically shaped and flexible. The stimulator includes an outer pad 202, an inner pad 204, and a connecting member 206.

When the stimulator 200 is in use, the inner pad 204 may lie against regions of the vagina. In certain embodiments, the inner pad 204 is configured to lie against the region of the vagina near the area which the G-spot is located. The outer pad 202 may lie against the pubic area. In certain embodiments, the outer pad 202 may lie against the clitoris area. The outer pad 202 may have a charging hole 208, which may receive power supply from the charger 300 through a plug 302. The outer pad 202 may also include a push button 210.

The stimulator 200 may have an additional connecting member branching from the connecting member 206. An additional pad may attach to the additional connecting member. The additional connecting member and the additional pad may be so configured that, when the stimulator is in use, the additional pad may lie against a third area of human body, such as anal area. The additional pad may also contain a vibrating motor.

The connecting member 206 may be in various shapes and sizes. In certain embodiments, the cross section of the connecting member 206 may be substantially in the shape of an ellipse. The cross section of the connecting member 206 may also be in other appropriate shape. The cross-section area of the connecting member 206 may be generally small compared to the cross-section area of the pad 202 and the pad 204. The size of cross section of the connecting member 206 may be uniform or may vary along the connecting member 206. The size and shape of the cross section of the connecting member 206 may be configured to minimize the obstruction to the vaginal opening.

The member 206 may be connected to the pad 202 and the pad 204 at the bottom of the pad 202 and the pad 204. The relative position of the connecting member 206 may be configured to minimize the obstruction to the vagina opening and the vagina. That is, position of the connecting member 206 may be configured to allow the insertion and movement of other objects that may be placed in the vagina. Thus, the stimulator 200 may be worn during a sexual intercourse or other activities and the male sex organ or other objects may enter the vagina and move therein without much obstruction.

The connecting member 206 may also be so configured that the stimulator 200 may maintain its position during use. That is, once a user places the stimulator 200 in a position for use, the vibration of the stimulator 200 and/or the body movement of the user and/or the user's partner may not cause the stimulator 200 to substantially relocate from the position the user places the stimulator 200.

The charger 300 includes a charging plug 302. The charging hole 208 may receive the charging plug 302 to receive electricity for an external out source, such as the house hold electricity supply.

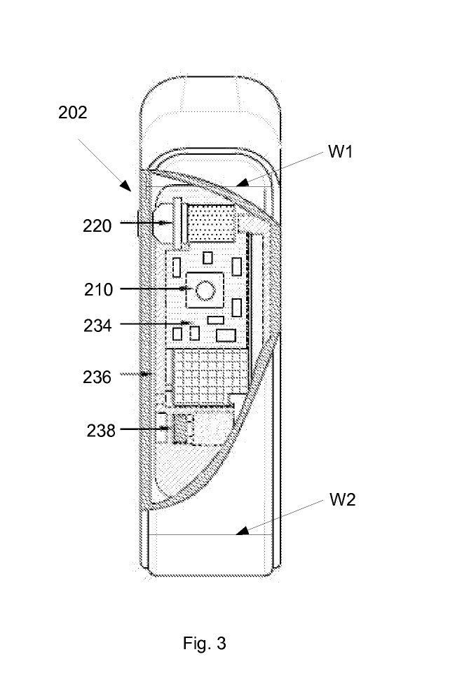

FIG. 2 illustrates a cross-sectional side view of an exemplary stimulator 200 consistent with the disclosed embodiments. As shown in FIG. 2, the stimulator 200 includes an outer shell 212. The connecting member 206 may include an inner core 214. The shell 212 forms a shell of the pad 202 enclosing a first chamber 216 and a shell of the pad 204 enclosing a second chamber 218. The shell 212 may be made of silicone, vinyl, rubber, or any other suitable material. The outer surface of the shell 212 may be substantially smooth to allow the smooth movement of other objects in vagina. The outer surface of the shell 212 may also have dimpling, texture or small protrusions features to enhance the stimulation, either to the female user or her partner. The inner core 214 may be made from a shape memory alloy like TiNi, or from a less expensive material, such as an elastic wire, thermoplastic elastomer, or a moulded nylon, polyurethane shell or any other suitable materials. The shell 212 and the inner core 214 may also be made from a combination of any suitable materials.

Within the first chamber 216, the stimulator 200 may include the push button 210, a charging socket 220, and a power source 222. Within the second chamber 218, the stimulator 200 may include a second vibrating motor 224. The motor 224 may be connected to the power source 222 in the first chamber 216 via an electric conducting wire 226.

As shown in FIG. 2, the pad 202 has an outer side 228 and an inner side 230. The pad 204 has an inner side 232 and an outer side 234. When the stimulator 200 is in use, the inner side 230 of the pad 202 may touch against a pubic area of the female user. In certain embodiments, the inner side 230 may touch against the clitoris area. The inner side 232 of the inner pad 204 may touch against a region of the vagina. In certain embodiments, the inner side 232 may touch against the region of the vagina near the area which the G-spot is located. A user may adjust the stimulator 200 so it may touch various human body parts when it is in use. A stimulating member 236 may be located on the inner side 232. The stimulating member 236 may be dimpling, texture or small protrusions features to enhance the stimulation.

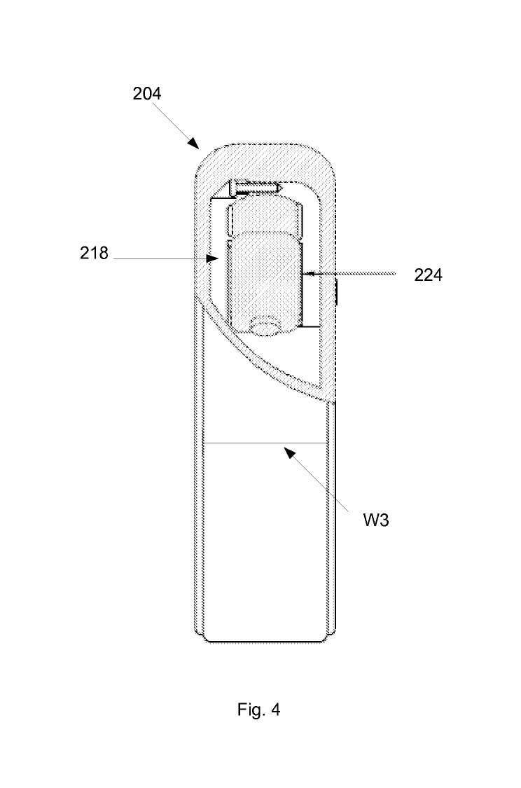

FIG. 3 illustrates a front view of the out pad 202 of an exemplary stimulator 200 consistent with the disclosed embodiments. As shown in FIG. 3, the outer pad 202 may be substantially in a shape of rectangle with a width dimension W1 when viewed from outer side 228 of the stimulator 200. The size of W1 may be adjusted. The outer pad 202 may be in other shapes. The shape and size of pad 202 may be configured so that the potential obstruction to the vagina opening and the potential obstruction to activities by the user may be minimized.

As shown in FIG. 3, the stimulator 200 may include the push button 210, the charging socket 220, the power source 222, a printed circuit board assembly (PCBA) 234, a supporting member 236, and a first vibrating motor 238 in the first chamber 216. The parts within the first chamber 216 may be positioned in any appropriate manners.

The connecting member 206 may be made as integral components of the stimulator 200. They may also be made separately and detachably attached to the pad 202 and the pad 204 during use. In certain embodiments, the connecting member 206 may be substantially in a shape of rectangle when viewed from outer side 228 of the stimulator 200. The connecting member 206 has a width dimension W2. In certain embodiments, the size of the dimension W2 is substantially similar to the size of the dimension W1.

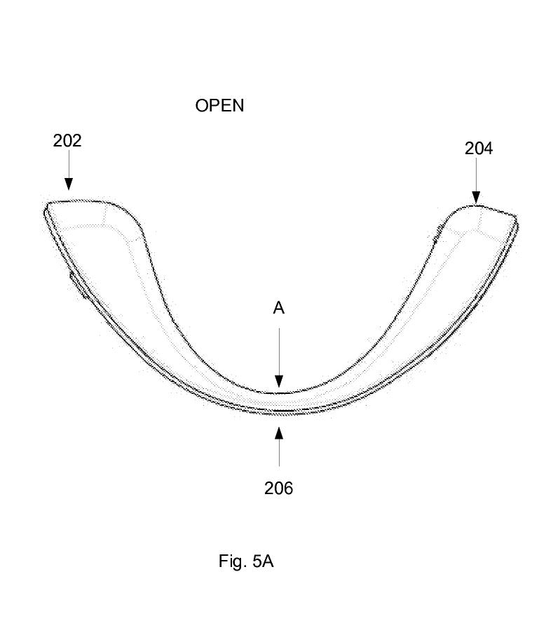

FIG. 4 illustrates a back view of the inner pad 204 of an exemplary stimulator 200 consistent with the disclosed embodiments. As shown in of FIG. 4, the inner pad 204 is substantially in a shape of rectangle with a width dimension W3 when viewed from outer side 234 of the stimulator 200. In certain embodiments, the size of W3 may be substantially similar to that of W1 and may be adjusted. The inner pad 204 may be in other shapes. The shape and size of pad 204 may be configured so that the potential obstruction to the vagina opening and the potential obstruction to other activities may be minimized. The stimulator 200 may include the second vibrating motor 224 in the second chamber 218.

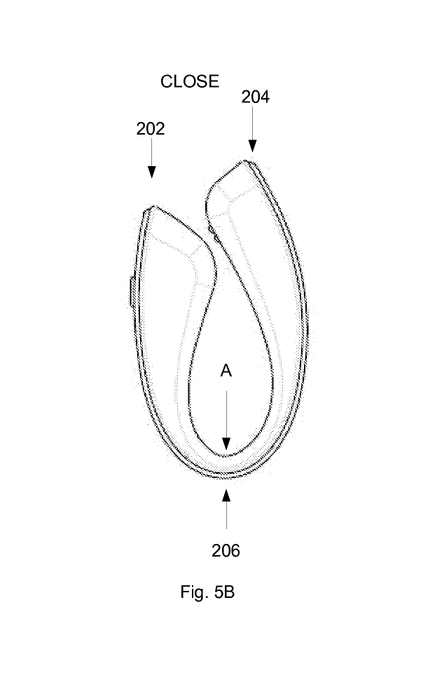

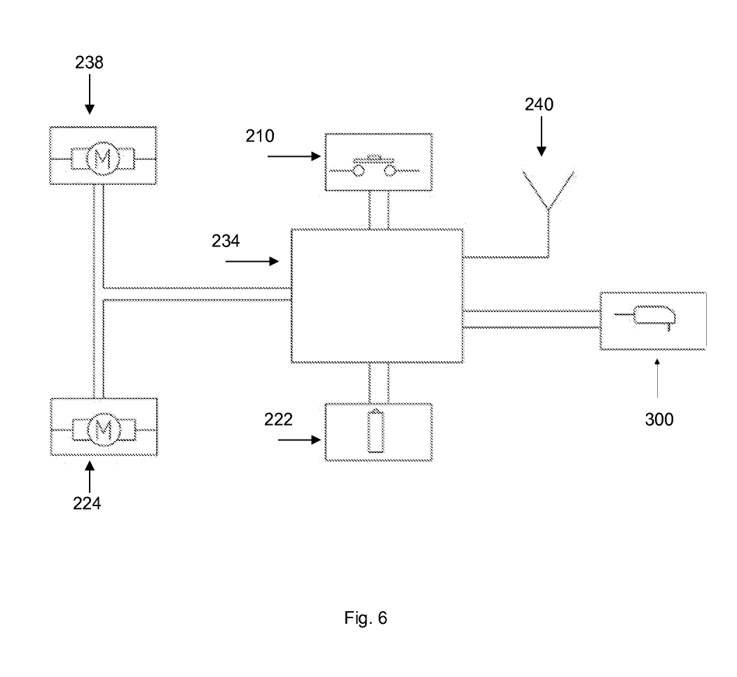

FIGS. 5A and 5B illustrates an exemplary stimulator 200 consistent with the disclosed embodiments. As shown in FIG. 5A, the stimulator 200 may be in an open state. The member 206 generally forms a “V” or “U” shape when the stimulator 200 is viewed from one side. When the stimulator 200 is in an open state, the angle A formed by the two arms of the “V” form is relatively larger and the pads 202 and 204 are separated from each other farther. As shown in FIG. 5B, when the stimulator 200 is in a close state, the angle A formed by the two arms of the “V” form is relatively smaller and the pads 202 and 204 are closer to each other. The two arms of the “V” may be adjusted so the angle A may be any angle between 0° and 180°.

The shell 212 and the core 214 may be made from materials that are flexible enough to be bent or extended and may also be sufficiently rigid to maintain the shape. Therefore, a user may adjust the angle A of the “V” without much difficulty. Meanwhile, the “V” shape may not be easily deformed during use of the stimulator 200. That is, the angle A of the “V” may be substantially maintained while one or two of the two pads 202 and 204 vibrate. When the stimulator 200 is in use and rubs against human body parts, sometimes quite vigorously, the angle A of the V may also be substantially maintained. That is, the connection member 206 is configured to maintain a first angle set by the user before use, and the user may set a second angle after the user for storage, or the user may change the angle during use.

A user may adjust the angle A of the “V” so the inner pad 204 makes contact with certain region within the vagina, and the outer pad 202 makes contact with the pubic area. In certain embodiment, the inner pad 204 may contact the region near where the G-spot is located and the outer pad 202 may contact the clitoris area. The stimulator 200 may be configured so a portion of the connecting member 206 may make contact with the front wall of the vagina when the inner pad 204 is inserted into the vagina to make contact with certain region within the vagina. The core 214 may be made of material that is resilient enough that the core 214 may push the pads 202 and 204, and/or the connecting member 206 against the body areas that they make contact with. The shell 212 and the core 214 may also be hard enough to protect the components and circuitry located therein.

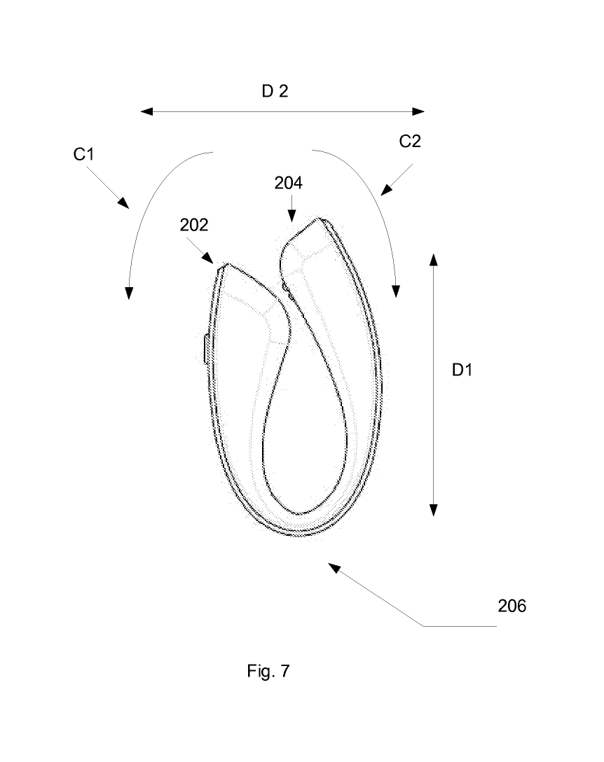

FIG. 6 illustrates an exemplary circuit diagram of an exemplary stimulator 200. As shown in FIG. 6, the circuit connects the push button 210, the PCBA 234, the power source 222, the first vibrating motor 238, the second vibrating motor 224, and a receiver antenna 240. The circuit may also connect to the charger 300. In certain embodiments, the PCBA 234, the power source 222, and the first vibrating motor 238 are located within the pad 202. The electrical connection between the PCBA 234, the power source 222, and the first vibrating motor 238 may be through pre-fabricated wire connection. The second vibrating motor 224 may be electrically connected to the circuit though the inner core 214 if the inner core 214 is made of a conductive material, or though the separate conductive wire 226 whether the inner core 214 is made of a conductive or a non-conductive material.

The first vibrating motor 238 and the second vibrating motor 224 are under the control of the PCBA 234. The PCBA 234 may turn on the first vibrating motor 238 and the second vibrating motor 224 simultaneously. The PCBA 234 may also only turn on one of the two vibrating motors 238 and 224 or turn off both of the two vibrating motors 238 and 224 as a user chooses. A user may choose to move/vibrate the pads 202 and/or 204 through mechanic means when the motors 238 and/or 224 are turned off.

The PCBA 234 may be pre-programmed for a variety of vibrating patterns to control the direction, frequency, and strength of the vibration of the different components of the stimulator 200, such as pad 202 and/or 204, and/or connecting member 206. The motors 238 and 224 may be configured to vibrate along various directions and dimensions and with various frequency and strength. The PCBA 234 may choose the same pattern for both motor 238 and 224. For example, the motor 238 and 224 may vibrate along the same direction with same frequency and/or strength. The PCBA 234 may also choose different patterns for motor 238 and 224. For example, the motor 238 and 224 may vibrate along different direction with different frequency and/or strength. The PCBA 234 may choose any combination of the vibration mechanisms for the two motor 238 and 224. The vibrating signal generated by the PCBA 234 may be transmitted to the motor 238 and 224 through the same electrical transmitting wire or a separate signal transmitting wire.

A user may select different vibrating patterns and the combinations of various vibrating patterns by pressing the push button 210. A user may also control the motors 238 and 224 through other appropriate means, such as a remote control. The PCBA 234 may receive signal from a remote through the receiver antenna 240 and control the vibrating motors 238 and 224 accordingly. The circuit and the motors of the stimulator 200 are powered by the power source 222. The power source 222 may or may not be rechargeable cell and, if rechargeable, may be recharged by receiving electricity from the charger 300 through the plug 302.

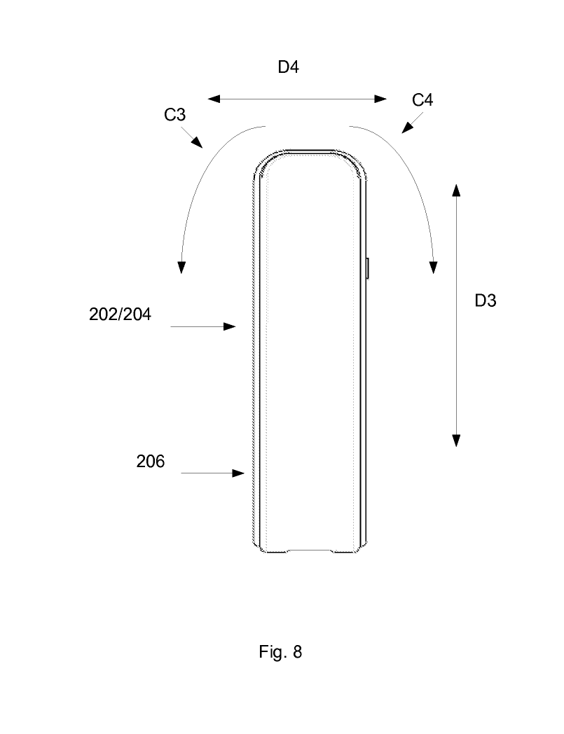

Under the drive of the motors 238 and 224, the pad 202 and the pad 204 may move/vibrate along different directions and/or dimensions. As shown in FIG. 7, the pads 202/204 and/or the connecting members 206 may move/vibrate along the first direction D1. The pad 202/204 may move/vibrate along the second direction D2. The first direction D1 and the second direction D2 may form any angle between 0° C. and 90° C. The pad 202 and the pad 204 may or may not move synchronously. Similarly, the connecting member 206 may or may not move synchronously. The pad 202, the pad 204, and the connecting member 206 may move/vibrate in a clockwise direction C2, or in a count-clockwise direction C1. The movement/vibration of the various components of the stimulator 200 may be one of various combinations of patterns.

The pad 202, the pad 204, and/or the connecting member 206 may vibrate along any one or more of the direction D1, D2, C1, and C2. During vibration along any one or more directions, the pad 202, the pad 204, and/or the connecting member 206 move continuously to and fro within a range at a frequency. The range and the frequency may be pre-determined and may be adjustable. The pads 202/204 and/or the connecting member 206 may also vibrate at different strength. That is, the vibrating component of the stimulator 200 may exert different force on the body part the stimulator 200 contacts. The strength may be pre-determined and may be adjustable.

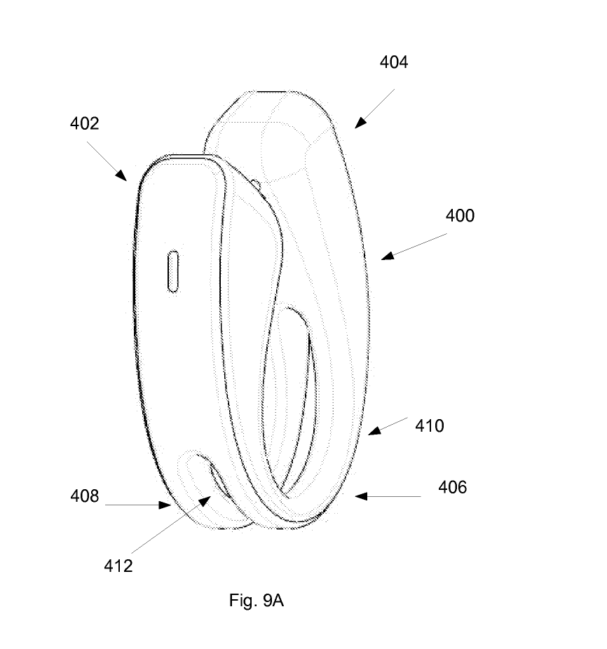

As shown in FIG. 8, the pad 202, the pad 204, and/or the connecting member 206 may move/vibrate along the third direction D3. The pad 202/204 may move/vibrate along the fourth direction D4. The third direction D3 and the fourth direction D4 may form any angle between 0° C. and 90° C. The pad 202, the pad 204, and/or the connecting member 206 may move/vibrate circularly in a clockwise direction C4, or in a count-clockwise direction C3.

Different components may move in a same direction, or in different directions. The movements/vibrations of the pad 202, the pad 204, and/or the connecting member 206 in the dimension as shown in FIG. 8 may form various combinations with the movement/vibration in the dimension as shown in FIG. 7.

The pad 202, the pad 204, and/or the connecting member 206 may vibrate along any one or more of the direction D3, D4, C3, and C4. During vibration along any one or more directions, the pad 202, the pad 204, and/or the connecting member 206 move continuously to and fro within a range at a frequency. The range and the frequency may be pre-determined and may be adjustable. The pads 202/204 and/or the connecting member 206 may also vibrate at a same or different strength. That is, the vibrating component of the stimulator 200 may exert same or different force on the body part the stimulator 200 contacts. The strength may be pre-determined and may be adjustable.

Thus, the PCBA 234 may generate a first vibrating pattern for the outer pad 202, a second vibrating pattern for the inner pad 204, and a third vibrating pattern for the connecting member 206. The first pattern may be a vibration along one or more direction of D1, D2, C1, and C2, and the vibration may be combined with a vibration along one or more direction of D3, D4, C3, and C4. The first pattern may also be a vibration along one or more direction of D3, D4, C3, and C4, and the vibration may be combined with a vibration along one or more direction of D1, D2, C1, and C2. The second pattern may be a vibration along one or more direction of D1, D2, C1, and C2, and the vibration may further combine with a vibration along one or more direction of D3, D4, C3, and C4. The second pattern may also be a vibration along one or more direction of D3, D4, C3, and C4, and the vibration may be combined with a vibration along one or more direction of D1, D2, C1, and C2. The third pattern may be a vibration along one or more direction of D1, D2, C1, and C2, and the vibration may further combine with a vibration along one or more direction of D3, D4, C3, and C4. The third pattern may also be a vibration along one or more direction of D3, D4, C3, and C4, and the vibration may be combined with a vibration along one or more direction of D1, D2, C1, and C2. The first, second, and third vibrating pattern may or may not be the same.

The materials for making the shell 212 and/or the core 214 may be of such a property to allow the vibrations of the pads 202 and/or 204, and/or the connecting member 206, as driven by the motors 238 and 224. For example, the shell 212 may be flexible enough to permit the pad 202 and 204 move along the first direction D1, the second direction D2, the third direction and the fourth direction D3. When vibrating, the pads 202/204 may move/vibrate longitudinally, transversely, vertically, and/or circularly along any directions and/or dimensions. The member 206 may also move/vibrate along any dimensions and/or directions as the vibrating signal may be transmitted to the connecting member 206. In the meantime, the shape of the stimulator 200 may be substantially maintained during vibration.

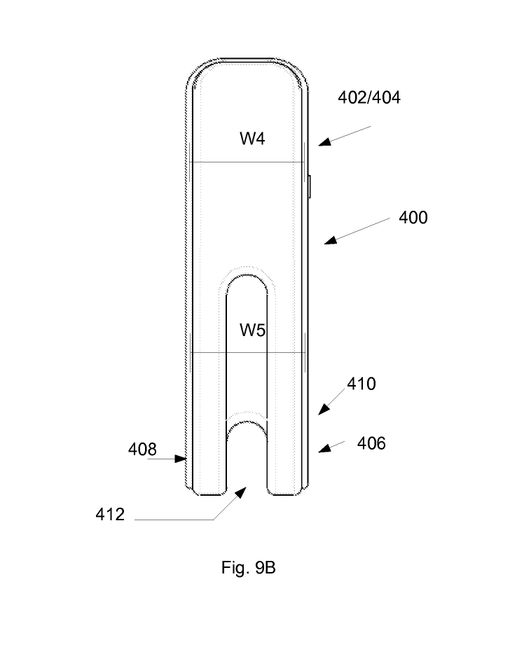

FIGS. 9A and 9B illustrate an exemplary device 400 consistent with the disclosed embodiments. As shown in FIGS. 9A and 9B, the device 400 includes an inner pad 404, an outer pad 402, and a connecting member 406. The connecting member 406 may include a first connecting structure 408 and a second structure 410. A cleft 412 is formed between the first structure 408 and the second structure 410.

The first structure 408 and the second structure 410 may be connected to the pad 402 at the two sides of the pad 402 close to the bottom of the pad 402 and to the pad 404 at the two sides of the pad 404 close to the bottom of the pad 404. The first structure 408 and the second structure 410 may be made as integral components of the stimulator 400. They may also be made separately and detachably attached to the pad 402 and the pad 404 during use.

The pads 402 and 404 may be in any appropriate shapes. In certain embodiments, the pads 402 and 404 are substantially in the shape of rectangle at a frontal or a back view as shown in FIG. 9B. The pads 402 and 404 have a width dimension W4. The materials used for the device 400 may be similar to those used for the device 200. The pads 402 and 404 may contain the similar internal component as the pad 202 and 204, respectively.

The first structure 408 and the second structure 410 may be in any appropriate shape and/or size. In certain embodiments, the first structure 408 and the second structure 410 may be substantially in the shape of elongated rectangle. The size and/or shape of the first structure 408 may or may not be the same as the size and/or shape of the second structure 410. The connecting member 406 has a width dimension W5. In certain embodiments, the size of dimension 5 may be similar to that of the dimension W4. The first structure 408 may include a core and/or wire similar to the core 214 and/or wire 226 in device 200. The core and/or wire may also be included in the second structure 410, or both.

The connecting structures 408 and 410 may be in various shapes and sizes. In certain embodiments, the cross section of the connecting structures 408 and 410 may be substantially in the shape of an ellipse. The cross section of the connecting structures 408 and 410 may also be in other appropriate shapes. The size of cross section of the connecting structures 408 and 410 may be uniform or may vary along the connecting structures 408 and 410. The size and shape of the cross sections of the connecting structures 408/410 may be configured to minimize the obstruction to the vaginal opening.

The relative position of the connecting structures 408/410 may be configured to minimize the obstruction to the vagina opening and the vagina. That is, the distance between the first connecting structure 408 and the second connecting structure 410 may be configured to allow the insertion and movement of other objects that may be placed in the vagina.

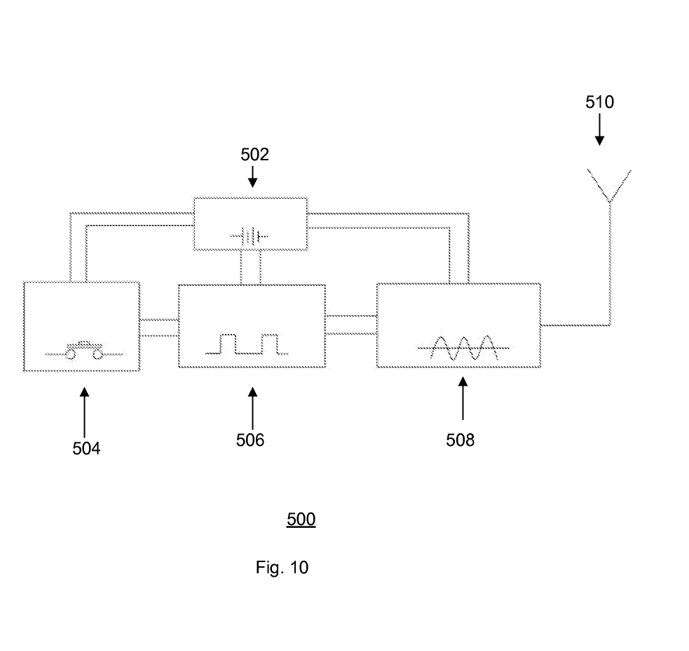

FIG. 10 illustrates an exemplary circuit diagram of an exemplary remote 500. As shown in FIG. 10, the circuit of the remote 500 includes a remote power source 502, a remote push button 504, a remote printed circuit board assembly (PCBA) 506, a remote transmitter circuit 508, and a transmitter antenna 510.

The remote PCBA 506 may be configured to generate a controlling signal for certain vibrating patterns or combinations of various vibrating patterns on the stimulator 200 or device 400. A user can select the controlling signals generated by remote PCBA 506 by pressing the push button 504.

The controlling signal generated by the remote PCBA 506 is sent to the transmitter circuit 508, which transform the controlling signal into an electromagnetic signal. The electromagnetic signal is transmitted through the transmitter antenna 510 and received through the receiver antenna 240 by the PCBA 234 in the stimulator 200. After receiving the signal, the PCBA 234 may generate vibrating pattern or a combination of various patterns according the signal. The vibrating pattern or the combination of various patterns that are ultimately controlled by the remote PCBA 506 may be similar to the vibrating pattern generated by PCBA 234 as described above. The remote circuit of the remote 500 may be powered by the power source 502, which may or may not be a rechargeable cell.

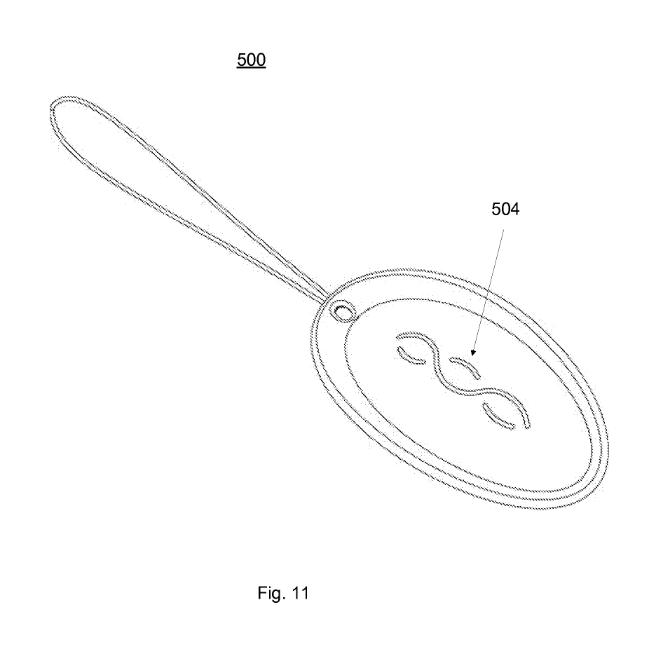

FIG. 11 illustrates an exemplary remote 500 consistent with the disclosed embodiments. The remote 500 may be made in the shape of a decorative object. The push button 504 may be made in a shape of an accessory part on the decorative object.

A device according to present disclosure may offer certain advantages. For example, a device according to present disclosure may stimulate several body areas. The dimension of the inner pad, the outer pad, and the connecting member may be so configured to generate stimulation to the body areas that the device contacts.

While various embodiments in accordance with the present invention have been shown and described, it is understood that the invention is not limited thereto. The present invention may be changed, modified and further applied by those skilled in the art. Therefore, this invention is not limited to the detail shown and described previously, but also includes all such changes and modifications. For example, the stimulator 200 may be made in different sizes to adjust the need of different persons.

What is claimed is:

1. A sexual stimulation device for a female user, comprising:
a first pad with a first width dimension configured for placement against a pubic area of the user;
a second pad with a second width dimension configured for placement inside a vagina of the user without significant obstruction;
a first vibrating motor placed into the first pad; and
a connecting member with a third width dimension for connecting the first pad and the second pad and configured to maintain a bending angle between the first pad and the second pad set by the user, wherein:
the first width dimension, the second width dimension, and the third width dimension are substantially similar, and
the first pad moves driven by the first vibrating motor.

2. The stimulation device of claim 1, further comprising an inner core, wherein:
the inner core is made of a material that can be configured to exert pressure upon the human body areas the first pad and the second pad lie against when the device is in use.

3. The stimulation device of claim 2, wherein the inner core is made of one or more of a shape memory material, an elastic wire, a thermoplastic elastomer, a moulded nylon, and a polyurethane shell.

4. The stimulation device of claim 1, further comprising:
a second vibrating motor placed into the second pad, wherein:
the first pad and the second pad move driven by at least one of the first vibrating motor and the second vibrating motor.

5. The stimulation device of claim 4, wherein:
the first vibrating motor is located within the first pad; and
the second vibrating motor is located within the second pad.

6. The stimulation device of claim 1, wherein:
the connecting member are in a shape substantially resembling the letter “V”.

7. The stimulation device of claim 1, further comprising a power source.

8. The stimulation device of claim 7, wherein the power source is a rechargeable battery.

9. The stimulation device of claim 1, further comprising a switch push button.

10. The stimulation device of claim 1, further comprising a printed circuit board assembly (PCBA)

11. The stimulation device of claim 10, wherein the PCBA is pre-programmed to generate a vibrating pattern.

12. The stimulation device of claim 11, wherein the PCBA is pre-programmed to generate a first vibrating pattern for the first pad, a second vibrating pattern for the second pad, and a third vibrating pattern for the member.

13. The stimulation device of claim 7, further comprising a remote.

14. The stimulation device of claim 13, wherein the remote includes a remote PCBA.

15. The stimulation device of claim 14, wherein the remote PCBA is pre-programmed to generate a vibrating pattern.

16. The stimulation device of claim 1, wherein the first pad is configured for placement against clitoral area.

17. The stimulation device of claim 1, wherein the second pad is configured for placement against the region of vagina near which the G-spot is located.

18. The stimulation device of claim 1, wherein the connecting member is configured to be in contact with the front wall of a vagina when the second pad is inserted into the vagina.

19. The stimulation device of claim 18, wherein the inner core is made of a material that can be configured to exert pressure upon the human body areas the connecting member contact with when the device is in use.

20. The stimulation device of claim 1, further comprising:
a first connecting structure, and a second connection structure.
